(19) United States
(12) Patent Application Publication
(10) Pub. No.: US 2018/0089074 A1
(43) Pub. Date: Mar. 29, 2018

(54) Techniques to Manage Key-Value Storage at a Memory or Storage Device

(71) Applicant: Intel Corporation, Santa Clara, CA (US)

(72) Inventors: Peng Li, Hillsboro, OR (US); Sanjeev N. Trika, Portland, OR (US)

(73) Assignee: Intel Corporation, Santa Clara, CA (US)

(21) Appl. No.: 15/279,279

(22) Filed: Sep. 28, 2016

(51) Int. Cl. G06F 12/02

(52) U.S. Cl. CPC G06F 12/0238; G06F 2212/202; G06F 2212/1008

(57) ABSTRACT

Examples may include techniques to manage key-value storage at a memory or storage device. A key-value command such as a put key-value command is received and data for a key and data for a value included in the put key-value command may be stored in one or more first non-volatile memory (NVM) devices maintained at a memory or storage device. A hash-to-physical (H2P) table or index is stored in one or more second NVM devices maintained at the memory or storage device. The H2P table or index is utilized to locate and read the data for the key and the data for the value responsive to other key-value commands.

### TECHNICAL FIELD

Examples described herein are generally related to use of key-value storage techniques to store data at a memory or storage device.

### BACKGROUND

Conventional key-value/object-storage systems such as databases or file-systems may be implemented via use of multiple layers of software between a top application layer and a bottom memory or storage device layer (e.g., solid state drive or hard disk drive). These multiple layers may include indirection systems, portable operating system interfaces (POSIXs), file systems, volume managers or memory/storage device drivers.

### BRIEF DESCRIPTION OF THE DRAWINGS

FIG. 1 illustrates an example system.

FIG. 2 illustrates an example scheme.

FIG. 3 illustrates an example first code.

FIG. 4 illustrates an example first logic flow.

FIG. 5 illustrates an example second logic flow.

FIG. 6 illustrates an example third logic flow.

FIG. 7 illustrates an example second code.

FIG. 8 illustrates an example apparatus.

FIG. 9 illustrates an example fourth logic flow.

FIG. 10 illustrates an example storage medium.

FIG. 11 illustrates an example memory or storage device.

### DETAILED DESCRIPTION

Multiple layers of software between a top application layer and a bottom memory or storage device layer for conventional key-value/object-storage systems may cause an increase in latencies to read/write data to memory or storage devices. The multiple layers may also cause increased central processor unit (CPU) utilization for processing elements at a host computing platform coupled with memory or storage devices. Both the increase in latencies and increase in host CPU utilization may lead to scaling issues as data requirements continue to grow.

According to some examples, in systems utilizing logical block addressing (LBA), one of the layers having a large impact on latencies and host CPU utilization is a layer associated with mapping from a key-value (KV) interface to LBAs. Mapping from a KV interface to LBAs may require use of multi-level sorted trees and host-side garbage collection and merges (e.g., log-structured merge (LSM) trees) on most types of data access workloads. In some examples, mapping from a KV interface to LBAs may introduce as much as a 10x write amplification due to use of multi-level sorted trees and host-side garbage collection and merges.

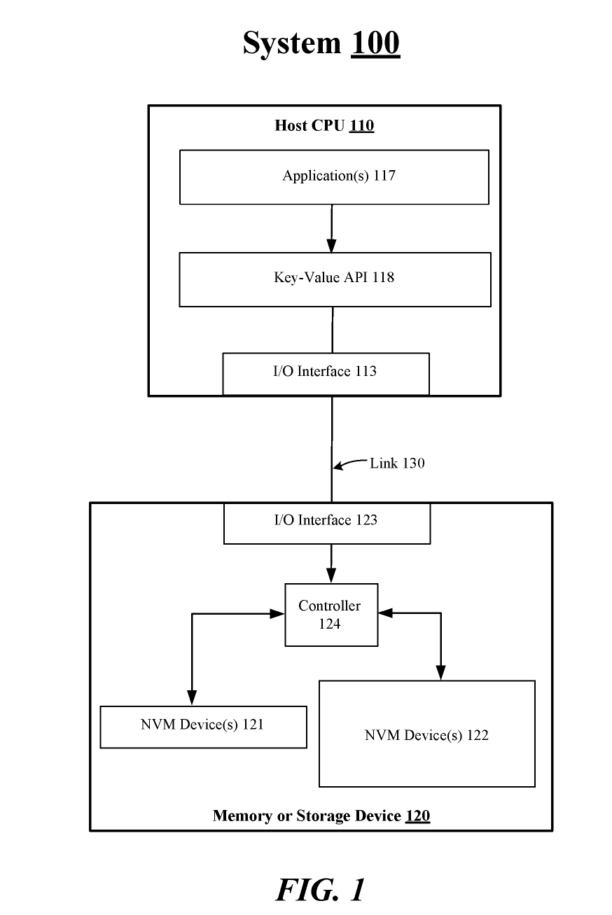

FIG. 1 illustrates an example system 100. In some examples, as shown in FIG. 1, system 100 includes a host CPU 110 coupled to a memory or storage device 120 through input/output (I/O) interface 113 and I/O interface 123. Also, as shown in FIG. 1, host CPU 110 may be arranged to execute one or more application(s) 117 and have a key-value application programming interface (API) 118. In some examples, as described more below, key-value API 118 may be arranged to enable elements of host CPU 110 to generate key-value commands that may be routed through I/O interface 113 and over a link 130 to memory or storage device 120. For these examples, memory or storage device 120 may serve as an object device for a key-value/object-storage system. Responsive to received key-value commands (e.g., get, put, delete or scan) logic and/or features at memory or storage device 120 such as a controller 124 may be capable of maintaining a key-to-physical mapping at non-volatile memory (NVM) device(s) 121 via use of a hash table or index and use this key-to-physical mapping to locate physical locations in NVM device(s) 122 arranged to store flexible sized key-value entries. Also, as described more below, defragmentation operations may be implemented by logic and/or features at memory or storage device 120 such as controller 124 in a manner that has little to no write amplification compared to host-side garbage-collection and merges such as LSM trees.

According to some examples, I/O interface 113, I/O interface 123 and link 130 may be arranged to operate according to one or more communication protocols and/or memory or storage access technologies. For examples, I/O interface 113, link 130 and I/O interface 123 may be arranged to use communication protocols according to the Peripheral Component Interconnect (PCI) Express Base Specification, revision 3.1a, published in December 2015 (“PCI Express specification” or “PCIe specification”) or according to one or more Ethernet standards promulgated by the Institute of Electrical and Electronics Engineers (IEEE) such as but not limited to IEEE 802.3-2012, Carrier sense Multiple access with Collision Detection (CSMA/CD) Access Method and Physical Layer Specifications, Published in December 2012 (hereinafter “IEEE 802.3 specification”). I/O interface 113, link 130 and I/O interface 123 may also be arranged to use memory or storage access technologies to include, but not limited to, the Non-Volatile Memory Express (NVMe) Specification, revision 1.2a, published in October 2015 (“NVMe specification”) or the Serial Attached SCSI (SAS) Specification, revision 3.0, published in November 2013 (“SAS-3 specification”). Also protocol extensions such as, but not limited to, NVMe over Fibre Channel (“NVMf”), the simple storage service (“S3”), Swift or Kinetic protocol extensions may be used to relay key-value commands from elements of host CPU 210 to elements of memory or storage device 120. In some examples, memory or storage device 120 may include, but is not limited to, a solid state drive or dual in-line memory module.

In some examples, host CPU 110 may be part of a host computing platform that may include, but is not limited to, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof

In some examples, host CPU 110 may include various commercially available processors, including without limitation an AMD® Athlon®, Duron® and Opteron® processors; NVIDIA® Tegra® processors, ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon® or Xeon Phi® processors; and similar processors.

According to some examples, NVM device(s) 121 and/or NVM device(s) 122 at memory or storage device 120 may be composed of one or more memory devices or dies which may include various types of non-volatile memory. The various types of non-volatile memory may include, but are not limited to, non-volatile types of memory such as 3-dimensional (3-D) cross-point memory that may be byte or block addressable. These byte or block addressable non-volatile types of memory may include, but are not limited to, memory that uses 3-D cross-point memory that uses chalcogenide phase change material (e.g., chalcogenide glass), multi-threshold level NAND flash memory, NOR flash memory, single or multi-level phase change memory (PCM), resistive memory, nanowire memory, ferroelectric transistor random access memory (FeTRAM), silicon-oxide-nitride-oxide-silicon (SONOS) memory, magnetoresistive random access memory (MRAM) memory that incorporates memristor technology, or spin transfer torque MRAM (STT-MRAM), or a combination of any of the above, or other non-volatile memory types.

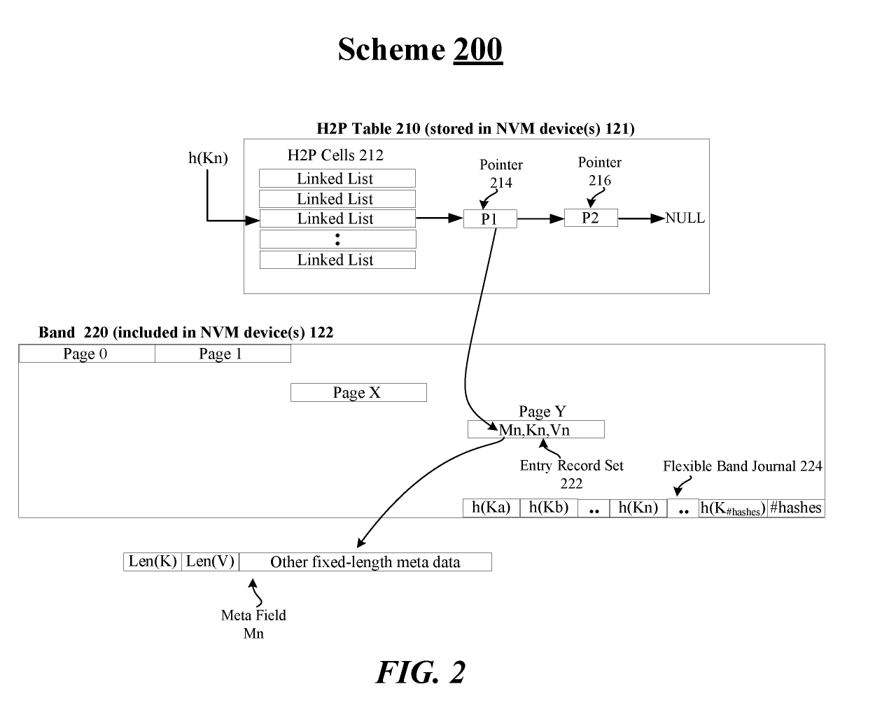

FIG. 2 illustrates example scheme 200. In some examples, as shown in FIG. 2, scheme 200 may illustrate an example of how key-to-physical mapping included in a hash-to-physical (H2P) table 210 may be used to locate physical locations in a band 220. For these examples, as shown in FIG. 2, H2P table 210 may be stored at NVM device(s) 121 and band 220 may be stored at NVM device(s) 122. In some examples, a given band such as band 220 may encompass or comprise multiple memory devices or dies included in NVM device(s) 122.

According to some examples, H2P table 210 may map user keys (K) to physical media address ranges (P). Although this disclosure is not limited to NAND types of non-volatile memory or media, P for NAND media may specify a band identifier, a memory page identifier and a byte-length of a key-value entry record that corresponds to K values stored on the NAND media. For example, P1 of pointer 214 may specify band 220, page Y and a byte-length of entry record set 222. In some examples, NVM device(s) 121 may be a type of non-volatile memory having relatively faster read/write access times compared to a type of NVM that includes NAND such as, but not limited to, 3-D cross-point memory that may include phase change memory that uses chalcogenide phase change material. For these examples, the 3-D cross-point memory for NVM device(s) 121 may be byte addressable.

In some examples, logic and/or features at storage or memory device 120 such as controller 124 may use any hash function “h”, and collision handling scheme to implement H2P table 210. For example, a linked-list per H2P cell 212 may be used for collision handling when using a hash function to generate hash values h(Kn) that results in selection of P1 for pointer 214 over P2 for pointer 216 as shown in FIG. 2.

According to some examples, each band maintained at NVM device(s) 122 may be arranged to contain one or more entry record sets such as entry record set 222 that include (Meta, Key, Value) fields. For example, Meta field “Mn” included in entry record set 222 may be a fixed length field containing lengths of corresponding key field “Kn” and value field “Vn” and optionally may also contain other field-length meta data such as, but not limited to, a cyclic redundancy check (CRC) data or compression information. Key field “Kn” and/or value field “Vn” may be of variable or flexible lengths.

In some examples, a flexible band journal 224 may be maintained at band 220 as shown in FIG. 2. For these examples, flexible band journal 224 may contain hashes or hash values of keys that map to entry record sets stored to band 220. For example, flexible band journal 224 includes hash h(Kn) that maps to entry record set 222 as shown in FIG. 2. Flexible band journal 224 may be deemed as flexible or variable due to the variable or flexible lengths allowed for in the key and/or value fields as mentioned above for entry record set 222. Depending on the lengths of the key and/or value fields of each entry record set stored to band 220, the number of hashes included in flexible band journal 224 may vary. For example, longer lengths of the key and/or value fields may fill up a storage capacity of a band 220 such that fewer hashes to map to these longer length entry record sets are needed compared to shorter length entry record sets.

According to some examples, as described more below, flexible band journal 224 may be utilized with a defragmentation code or algorithm implemented by logic and/or features at memory or storage device 120 to allow for efficient defragmentation operations. For these examples, hashes such as h(K_{#hashes}) and information such as #hashes included in flexible band journal 224 may be used to facilitate these efficient defragmentation operations.

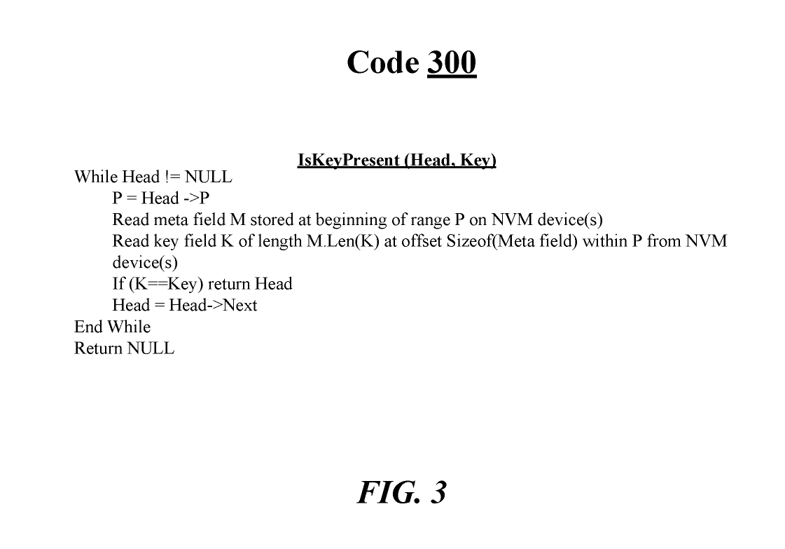

FIG. 3 illustrates an example code 300. In some examples, as shown in FIG. 3, code 300 may include an algorithm or pseudocode identified as IsKeyPresent(Head, Key). IsKeyPresent(Head, Key) may be for use to determine whether a given key value (“Key”) include in an H2P table such as H2P table 210 is present or stored in memory or storage media at a storage device such as memory or storage device 120. For these example, the memory or storage media may be NAND that includes one or more NAND bands such as band 220.

According to some examples, the IsKeyPresent(Head, Key) algorithm may result in selecting a P obtained based on a hash generated using Key and selected via use of a linked list included in H2P cells 212. For example, pointer 214 may be obtained and selected as shown in FIG. 2. Pointer 214 may then be used to read meta field “Mn” of entry record set 222. Then if data read from key field “Kn” of entry record set 222 matches Key, the Key is deemed as being present or stored in band 220. If data read from key field “Kn” does not match Key, the Key is deemed as not being present or stored in band 220.

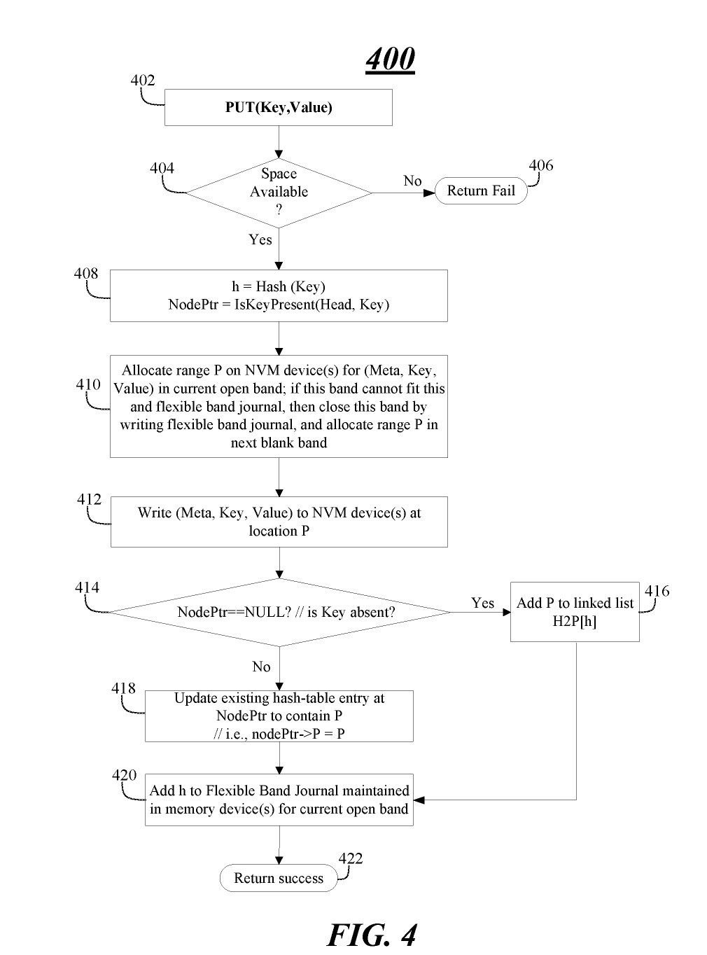

FIG. 4 illustrates an example logic flow 400. In some examples, logic flow 400 may be for handling a type of key-value command received from elements of a host CPU such as host CPU 110 shown in FIG. 1. The type of key-value command may be a put key-value command to cause a Key and Value to be stored as an entry record set at a memory or storage device. For these examples, elements of memory or storage device 120 such as I/O interface 123, controller 124, NVM device(s) 121 or NVM device(s) 122 as shown in FIG. 1 may be related to logic flow 400. Also, aspects of scheme 200 and code 300 as shown in FIGS. 2-3 may be related to logic flow 400. However, example logic flow 400 is not limited to implementations using elements, schemes or codes as shown in FIGS. 1-3.

Beginning at block 402, an element of host CPU 110 such as application(s) 117 may utilize key-value API 118 to generate a put key-value command PUT(Key, Value) and cause the Put key-value command to be routed through I/O interface 113 and over link 130 to be received by memory or storage device 120 through I/O interface 123. In some examples, Key may include data for a key and Value may include data for a value to be stored in one or more NVM devices maintained at memory or storage device 120 such as NVM device(s) 122. For these examples, the put key-value command may be received by logic and/or features of controller 124.

At decision block 404, logic and/or features of controller 124 may determine whether space is available in NVM device(s) 122 to store data for Key and data for Value as well as space to maintain a flexible band journal. In some examples, NVM device(s) 122 may include non-volatile types of memory such as NAND memory. For these examples, the logic and/or features of controller 124 may determine whether one or more NAND bands that may include NAND band 220 have enough space.

At block 406, logic and/or features of controller 124 determined that space is not available. In some examples, logic and/or features of controller 124 may return a fail indication to indicate that the put key-value command has failed.

At block 408, logic and/or features of controller 124 determined that space is available. According to some examples, logic and/or features of controller 124 may generate a hash or hash value “h” based on Key and then implement the IsKeyPresent(H2P[h], Key) algorithm shown in FIG. 3 to determine if Key has previously been stored to NVM device(s) 122.

At block 410, logic and/or features of controller 124 may allocate a range of physical memory addresses P at NVM device(s) 122 for an entry record set that includes (Meta, Key, Value) fields in a currently open band. In some examples, if the currently open band cannot fit the entry record set and a flexible band journal, then the logic and/or features of controller 124 may close the open band by writing or completing the flexible band journal and then allocate the range of physical memory addresses P in a next blank band included in NVM device(s) 122. 100351 At block 412, logic and/or features of controller 124 may write the entry record set that includes (Meta, Key, Value) to a NAND band included in NVM device(s) 122 at physical memory address location P.

At decision block 414, logic and/or features of controller 124 may determine whether implementation of the IsKeyPresent(Head, Key) algorithm indicated that the Key was absent or was found to be stored at NVM device(s) 122.

At block 416, logic and/or features of controller 124 determined that the Key was absent. In some examples, logic and/or features of controller 124 may add P to a linked list associated with an H2P table stored in one or more NVM devices separate from NVM device(s) 122. For these examples, the one or more NVM devices may be maintained in NVM device(s) 121 and the H2P table may be H2P table 210. H2P[h] may result from use of Key in a hash function to generate hash h and H2P cells 212 may be used to select P based on h in order to locate where in NVM device(s) 122 the entry set for Key and Value has been stored.

At block 418, logic and/or features of controller 124 determined that the Key was not absent. According to some examples, logic and/or features of controller 124 may update H2P table 210 to contain P in H2P cells 212 when using Key in a hash function to generate hash h.

At block 420, logic and/or features of controller 124 may add h for the Key to a flexible band journal maintained in NVM device(s) 122 for the currently open band.

At block 422, logic and/or features of controller 124 may return a success indication to indicate that the put key-value command has been successfully implemented and data for both the Key and the Value has been stored to memory or storage device 120.

In some examples, data for Keys and/or data for Values may be stored to NVM device(s) 122 in a compressed state. For these examples, the data for Keys and/or data for Values may be compressed with a codec as they are stored to NVM device(s) 122 and decompressed when read from NVM device(s) 122. The lengths stored in Meta fields of respective entry records may indicate compressed lengths.

According to some examples, logic and/or features of controller 124 may impose granularity and size restrictions on data for Keys and/or data for Values, thereby reducing an amount of space needed for entry records stored to NVM device(s) 122. For example, entry records may be limited to support only fixed size (e.g., exactly 8 byte) Keys. In this case, the key-length need not be stored in entry records.

In some examples, memory or storage device 120 may be arranged to support only small (e.g., up to 8 byte) Keys. For these examples, Keys and key-lengths may be stored in NVM device(s) 121 rather than at NVM device(s) 122 with the entry records stored at NVM device(s) 122 holding data for respective Values.

According to some examples, rather than maintaining a key-length in a Meta field at NVM device(s) 122, data for Key and data for Value may be separated by a special character, e.g., ‘/0’. This separation by the special character may provide additional compaction for cases where Keys may be known to be character-strings rather than byte-strings.

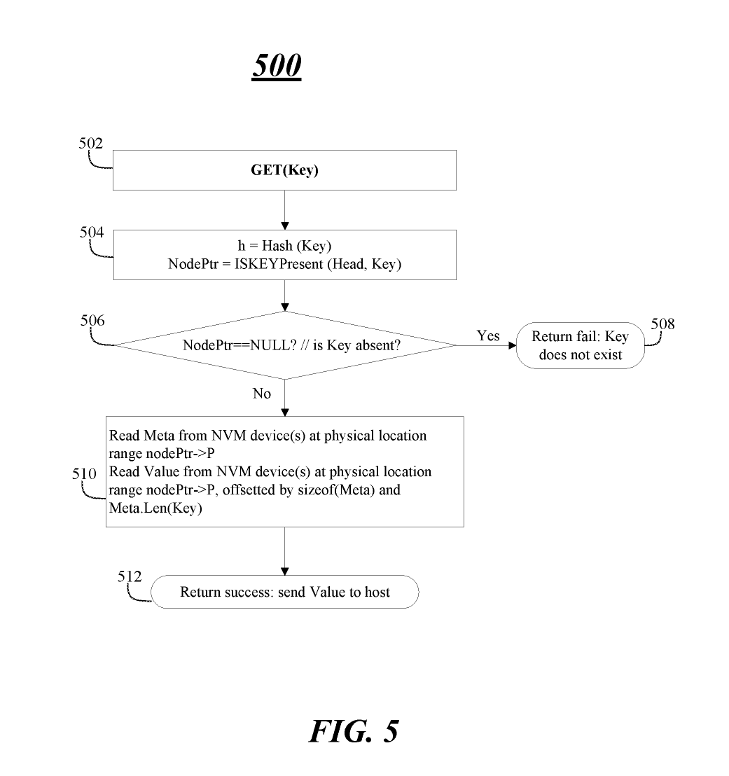

FIG. 5 illustrates an example logic flow 500. In some examples, logic flow 500 may be for handling a type of key-value command received from elements of a host CPU such as host CPU 110 shown in FIG. 1. The type of key-value command may be a get key-value command to obtain a Key and read an entry record set stored to a memory or storage device. For these examples, elements of memory or storage device 120 such as I/O interface 123, controller 124, NVM device(s) 121 or NVM device(s) 122 as shown in FIG. 1 may be related to logic flow 500. Also, aspects of scheme 200, code 300 or logic flow 400 as shown in FIGS. 2-4 may be related to logic flow 500. However, example logic flow 500 is not limited to implementations using elements, schemes, codes or logic flows as shown in FIGS. 1-4.

Beginning at block 502, an element of host CPU 110 such as application(s) 117 may utilize key-value API 118 to generate a get key-value command GET(Key) and cause the get key-value command to be routed through I/O interface 113 and over link 130 to be received by memory or storage device 120 through I/O interface 123. In some examples, Key may include data for retrieving a value stored in one or more NVM devices maintained at memory or storage device 120 such as NVM device(s) 122. For these examples, the get key-value command may be received by logic and/or features of controller 124.

At block 504, logic and/or features of controller 124 may generate a hash or hash value “h” based on Key and then implement the IsKeyPresent(Head, Key) algorithm shown in FIG. 3 to determine whether or not Key has previously been stored to NVM device(s) 122.

At decision block 506, logic and/or features of controller 124 may determine whether implementation of the IsKeyPresent(H2P[h], Key) algorithm indicated that the Key was absent or was found to be stored at NVM device(s) 122.

At block 508 logic and/or features of controller 124 determined that Key was absent or has not been stored to NVM device(s) 122 or does not exist. In some examples, logic and/or features of controller 124 may return a fail indication to indicate that Key was absent or does not exist at memory or storage device 120.

At block 510, logic and/or features of controller 124 determined that Key was stored to NVM device(s) 122. According to some examples, logic and/or features of controller 124 may read Meta data from a Meta field for the entry record set pointed to by P and then read value data from a Value field for the entry record set.

At block 512, logic and/or features of controller 124 may return a success indication to indicate that the get key-value command has been successfully implemented. In some examples, the success indication may include the value data read from the Value field for the entry record set.

According to some examples, another type of key-value command may be a receive by logic and/or features of controller 124. The other type of key-value command may be a scan key-value command. For these examples, a scan key-value command such as Scan(Key1,Key2) may be received. A Scan(Key1, Key2) may be similar to a get key-value command but rather than asking for a data associated with a single Key, multiple Keys may be scanned and corresponding Value data may be returned to the requestor or source of the scan key-value command. A sorted link-list may be maintained with H2P table 210 at NVM device(s) 221 to facilitate implementing this type of key-value command.

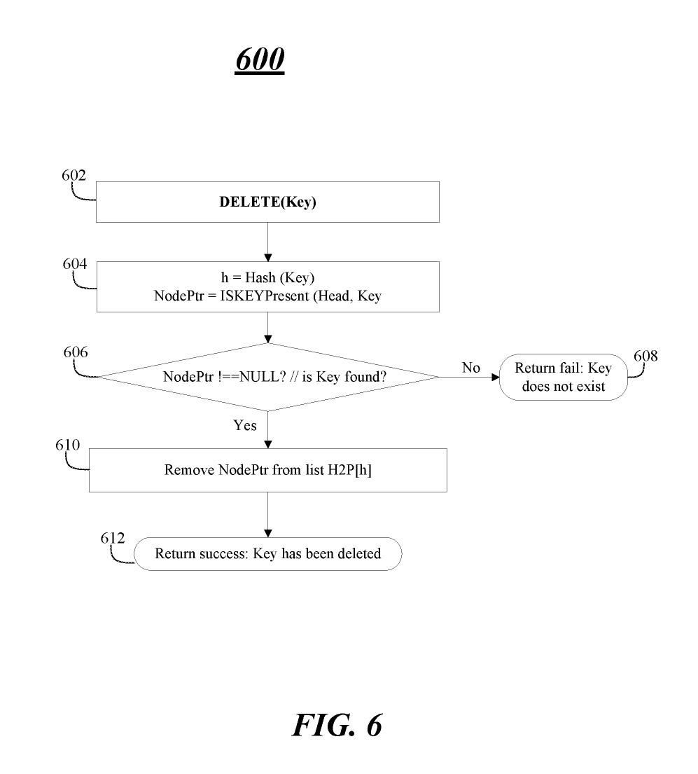

FIG. 6 illustrates an example logic flow 600. In some examples, logic flow 600 may be for handling a type of key-value command received from elements of a host CPU such as host CPU 110 shown in FIG. 1. The type of key-value command may be a delete key-value command to delete a Key used for accessing an entry record set stored to a memory or storage device. For these examples, elements of memory or storage device 120 such as I/O interface 123, controller 124, NVM device(s) 121 or NVM device(s) 122 as shown in FIG. 1 may be related to logic flow 600. Also, aspects of scheme 200, code 300 or logic flow 400 as shown in FIGS. 2-4 may be related to logic flow 600. However, example logic flow 600 is not limited to implementations using elements, schemes, codes or logic flows as shown in FIGS. 1-4.

Beginning at block 602, an element of host CPU 110 such as application(s) 117 may utilize key-value API 118 to generate a delete key-value command delete (Key) and cause the delete key-value command to be routed through I/O interface 113 and over link 130 to be received by memory or storage device 120 through I/O interface 123. In some examples, Key may include data for causing a value stored in one or more NVM devices maintained at memory or storage device 120 such as NVM device(s) 122 to eventually be deleted. For these examples, the delete key-value command may be received by logic and/or features of controller 124.

At block 604, logic and/or features of controller 124 may generate a hash or hash value “h” based on Key and then implement the IsKeyPresent(Head, Key) algorithm shown in FIG. 3 to determine whether Key has previously been stored to NVM device(s) 122.

At decision block 606, logic and/or features of controller 124 may determine whether implementation of the IsKeyPresent(Head, Key) algorithm indicated that the Key was found to be stored at NVM device(s) 122.

At block 608, logic and/or features of controller 124 determined that Key has not been stored to NVM device(s) 122 or does not exist. In some examples, logic and/or features of controller 124 may return a fail indication to indicate that Key does not exist at memory or storage device 120.

At block 610, logic and/or features of controller 124 determined that Key was stored to NVM device(s) 122. According to some examples, logic and/or features of controller 124 may remove the pointer for P in H2P cells 212 of H2P table 210 stored at memory device(s) 121 that may be generated when using Key in a hash function to generate hash h. For these examples, the data for an entry record set stored to NVM device(s) 122 may not be deleted at this time. Rather, the data for the entry record set stored to NVM device(s) 122 may be deleted or erased later in a defragmentation operation.

At block 612, logic and/or features of controller 124 may return a success indication to indicate that the delete key-value command has been successfully implemented and Key has been deleted.

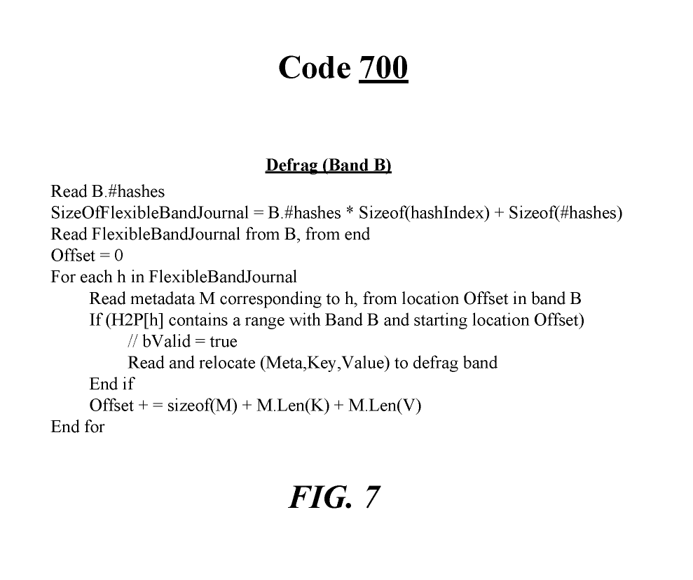

FIG. 7 illustrates an example code 700. In some examples, as shown in FIG. 7, code 700 may include an algorithm or pseudocode identified as Defrag (Band B). For these examples, the Defrag (Band B) algorithm may for a defragmentation operation at a Band B in order to defragment a given band for one or more memory devices via use of information included in a flexible band journal maintained at the given band. For example, Band B may be formatted similarly to NAND band 220 included in NVM device(s) 122 at memory or storage device 120 as shown in FIG. 2 and the flexible band journal maintained at the given band may be similar to flexible band journal 224 also as shown in FIG. 2.

According to some examples, logic and/or features of controller 124 at memory or storage device 120 may implement the Defrag (Band B) algorithm as part of periodic background operations that may be based on on-demand requests, completed at fixed time intervals or responsive to memory device capacity issues (e.g., all bands deemed as lacking capacity to store additional entry records and journals). The Defrag (Band B) algorithm may cause logic and/or features of controller 124 to read a number of hashes maintained in the flexible band journal 124. A hash h to where the number of hashes may be read may be included in H2P table 210 stored at NVM device(s) 121(e.g., h(K_{#hashes})). The Defrag (Band B) algorithm may then cause logic and/or features of controller 124 to determine a size of flexible band journal 124 and then read hash values or hashes h for respective Keys from the flexible band journal to determine which h's for respective Keys read from flexible band journal 124 still have a P included in H2P cells 212 of H2P table 210 and thus entry records pointed to by these P's are deemed as still having valid data.

In some examples, for those h's for respective Keys read from flexible band journal 124 that were found to still have a P included in H2P cells 212 of H2P table 210, Defrag (Band B) algorithm may then cause logic and/or features of controller 124 to read (Meta, Key, Value) fields for each respective entry record found to still have valid data. For these examples, the read (Meta, Key, Value) fields may be relocated to a different band. NAND band 220 may then be erased in order to complete the defragmentation operation of NAND band 220. This type of entry record granularity to determine valid entry records for defragmentation may be more efficient than page-based validity determinations common in some other defragmentation operations.

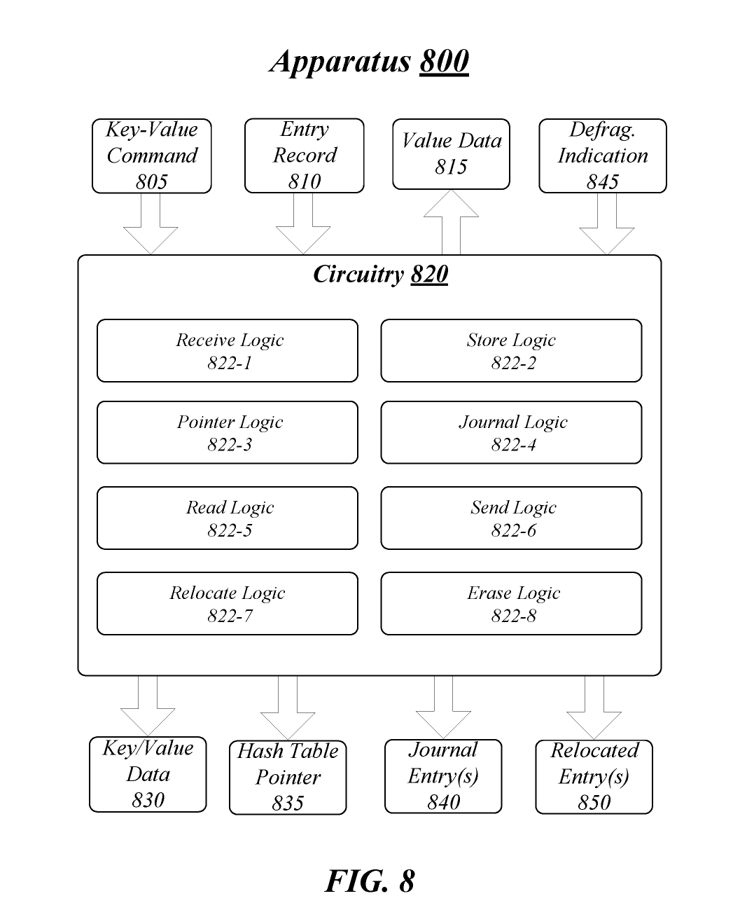

FIG. 8 illustrates an example block diagram for an apparatus 800. Although apparatus 800 shown in FIG. 8 has a limited number of elements in a certain topology, it may be appreciated that the apparatus 800 may include more or less elements in alternate topologies as desired for a given implementation.

The apparatus 800 may be supported by circuitry 820 and may be maintained or located at a controller for a memory or storage device such as controller 124 for memory or storage device 120 of system 100 shown in FIG. 1 and described above. Circuitry 820 may be arranged to execute one or more software or firmware implemented components or logic 822-a . It is worthy to note that “a” and “b” and “c” and similar designators as used herein are intended to be variables representing any positive integer. Thus, for example, if an implementation sets a value for a=8, then a complete set of software or firmware for components or logic 822-a may include components or logic 822-1, 822-2, 822-3, 822-4, 822-5, 822-6, 822-7 or 822-8. The examples presented are not limited in this context and the different variables used throughout may represent the same or different integer values. Also, these “components” or “logic” may be software/firmware stored in computer-readable media, and although the logic shown in FIG. 8 is depicted as discrete boxes, this does not limit this logic to storage in distinct computer-readable media components (e.g., a separate memory, etc.).

According to some examples, circuitry 820 may include a processor or processor circuitry. Circuitry 820 may be generally arranged to execute logic 822-a . The processor or processor circuitry can be any of various commercially available processors, including without limitation an AMD® Athlon®, Duron® and Opteron® processors; NVIDIA® Tegra® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon®, Xeon Phi® and XScale® processors; and similar processors. According to some examples circuitry 820 may also be an application specific integrated circuit (ASIC) and at least some components or logic 822-a may be implemented as hardware elements of the ASIC. In some examples, circuitry 820 may also include a field programmable gate array (FPGA) and at least some logic 822-a may be implemented as hardware elements of the FPGA.

According to some examples, apparatus 800 may include a receive logic 822-1. Receive logic 822-1 may be executed by circuitry 820 to receive a key-value put command that includes data for a key and data for a value, the data for the key and the data for the value to be stored to one or more first NVM devices maintained at the memory or storage device. For these examples, the key-value put command may be included in key-value command 805. In other examples, subsequent commands may be received by receive logic 822-1 that may include at least the data for the key may be received. For example, key-value get, delete or scan commands may include the data for the key.

In some examples, apparatus 800 may also include a store logic 822-2. Store logic 822-2 may be executed by circuitry 820 to cause the data for the key and the data for the value to be stored in the one or more first NVM devices as an entry record at a physical address range. For these examples, the data for the key and the data for the value may be included in key/value data 830.

According to some examples, apparatus 800 may also include a pointer logic 822-3. Pointer logic 822-3 may be executed by circuitry 820 to add a pointer to a hash table to map a hash value to the entry record at the physical address range, the hash value generated via use of the data for the key, the hash table stored in one or more second NVM devices maintained at the memory or storage device. For these examples, the pointer may be included in hash table pointer 835. In some examples, the pointer may be added to a link that may be used to select the pointer based on the hash value.

In some examples, apparatus 800 may also include a journal logic 822-4. Journal logic 822-4 may be executed by circuitry 820 to cause the hash value to be maintained in a journal stored in the one or more first NVM devices. For these examples, the hash value may be included in journal entry(s) 840.

According to some examples, apparatus 800 may also include a read logic 822-5. Read logic 822-5 may be executed by circuitry 820 to read the entry record stored in the one or more first NVM devices based on the pointer to obtain the data for the value. For these examples, the entry record read may be included in entry record 810. Read logic 822-5 may read the entry record responsive to a key-value get command or a key-value scan command received by receive logic and using a pointer selected by pointer logic 822-3.

In some examples, apparatus 800 may also include a send logic 822-6. Send logic 822-6 may be executed by circuitry 820 to send the data for the value to a source of the key-value get command or the key-value scan command that caused read logic 822-5 to read the entry record. For these examples, value data 815 may include the data for the value sent to the source.

According to some examples, the entry record and the journal stored in the one or more first NVM devices may be stored in a first band included in the one or more first NVM devices. For examples, receive logic 822-1 may receive an indication to implement a defragmentation operation on the first band. The indication (e.g., time interval expired, on-demand request or capacity full indication) may be included in defragmentation indication 845. Read logic 822-5 may then read data from the journal to determine which hashes maintained in the journal correspond to pointers included in the hash table stored in the one or more second NVM devices. Journal logic 822-4 may then determine that hashes having corresponding pointers include valid data in respective entry records for the corresponding pointers. Read logic 822-5 may then read the respective entry records. A relocate logic 822-7 also included in apparatus 800 may be executed by circuitry 820 to relocate the valid data in the respective entry records to a second band included in the one or more first NVM devices. The relocated entry records may be included in relocated entry(s) 850. An erase logic 822-8 also included in apparatus 800 may be executed by circuitry 820 to erase the data stored in the first band.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

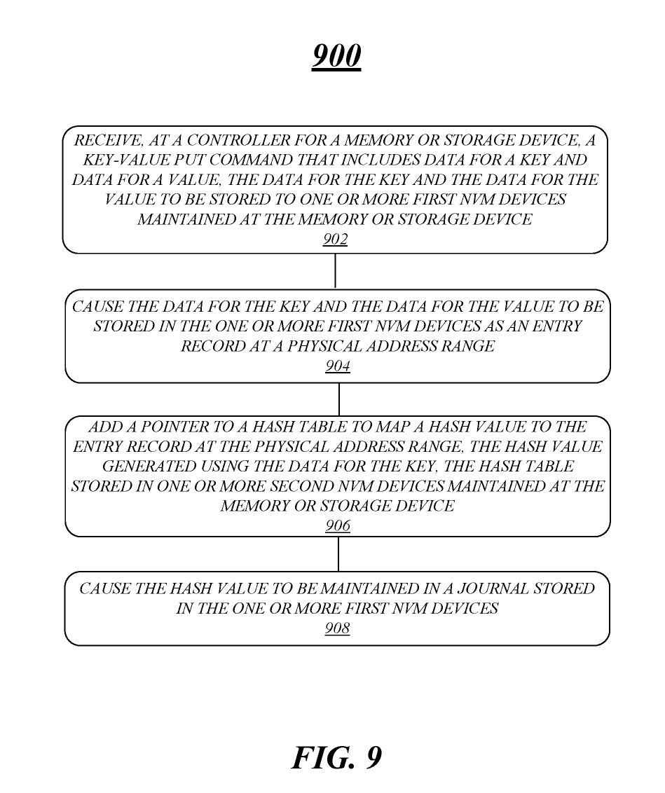

FIG. 9 illustrates an example logic flow 900. As shown in FIG. 9 the first logic flow includes a logic flow 900. Logic flow 900 may be representative of some or all of the operations executed by one or more logic, features, or devices described herein, such as apparatus 800. More particularly, logic flow 900 may be implemented by receive logic 822-1, store logic 822-2, pointer logic 822-3, journal logic 822-4, read logic 822-5, send logic 822-6, relocate logic 822-7 or erase logic 822-8.

According to some examples, logic flow 900 at block 902 may receive, at a controller for a memory or storage device, a key-value put command that includes data for a key and data for a value, the data for the key and the data for the value to be stored to one or more first NVM devices maintained at the memory or storage device. For these examples, receive logic 822-1 may receive the key-value put command.

In some examples, logic flow 900 at block 904 may cause the data for the key and the data for the value to be stored in the one or more first NVM devices as an entry record at a physical address range. For these examples, store logic 822-2 may cause the data for the key and the data for the value to be stored in the one or more first NVM devices as the entry record at the physical address range.

According to some examples, logic flow 900 at block 906 may add a pointer to a hash table to map a hash value to the entry record at the physical address range, the hash value generated using the data for the key, the hash table stored in one or more second NVM devices maintained at the memory or storage device. For these examples, pointer logic 822-3 add the pointer to the hash table.

In some examples, logic flow 900 at block 908 may cause the hash value to be maintained in a journal stored in the one or more first NVM devices. For these examples, journal logic 822-4 may cause the hash value to be maintained in the journal.

In some examples, rather than copy the data structure to the persistent memory, a persistent memory file may be maintained based on allocated persistent memory being utilized by applications to create data structures in a mapped persistent memory file. For an allocated portion of the persistent memory that is mapped all reference offsets for these data structures may hold values that are offsets from a based pointer of the mapped persistent memory file. This may result in a single instance of these data structures existing in respective mapped persistent memory files and hence to need to copy.

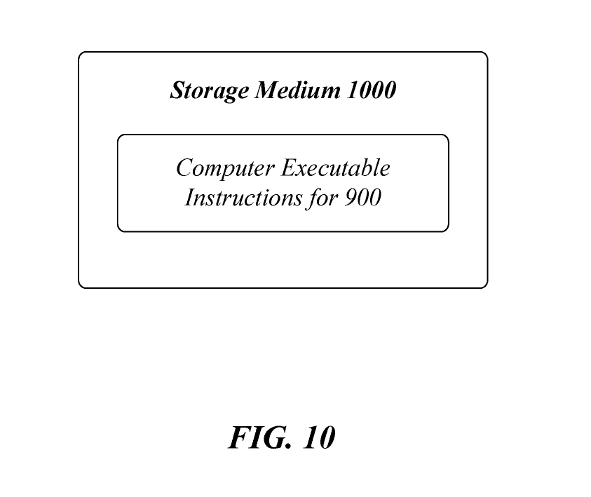

FIG. 10 illustrates an example storage medium 1000. As shown in FIG. 10, the first storage medium includes a storage medium 1000. The storage medium 1000 may comprise an article of manufacture. In some examples, storage medium 1000 may include any non-transitory computer readable medium or machine readable medium, such as an optical, magnetic or semiconductor storage. Storage medium 1000 may store various types of computer executable instructions, such as instructions to implement logic flow 900. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

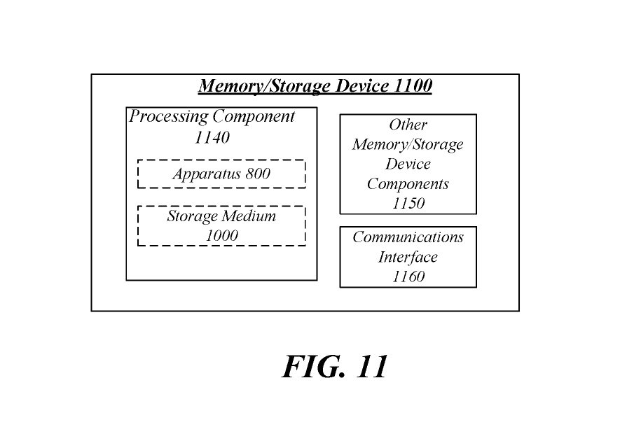

FIG. 11 illustrates an example memory/storage device 1100. In some examples, as shown in FIG. 11, memory/storage device 1100 may include a processing component 1140, other storage device components 1150 or a communications interface 1160. According to some examples, memory/storage device 1100 may be capable of being coupled to a host CPU of a host computing device or platform. For example, host CPU 110 shown in FIG. 1. Also, memory/storage device 1100 may be similar to memory or storage device 120 shown in FIG. 1.

According to some examples, processing component 1140 may execute processing operations or logic for apparatus 800 and/or storage medium 1000. Processing component 1140 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, ASIC, programmable logic devices (PLD), digital signal processors (DSP), FPGA/programmable logic, memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software components, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other storage device components 1150 may include common computing elements or circuitry, such as one or more processors, multi-core processors, co-processors, memory units, chipsets, controllers, interfaces, oscillators, timing devices, power supplies, and so forth. Examples of memory units may include without limitation various types of computer readable and/or machine readable storage media in the form of one or more higher speed memory units, such as read-only memory (ROM), RAM, DRAM, DDR DRAM, synchronous DRAM (SDRAM), DDR SDRAM, SRAM, programmable ROM (PROM), EPROM, EEPROM, flash memory, ferroelectric memory, SONOS memory, polymer memory such as ferroelectric polymer memory, nanowire, FeTRAM or FeRAM, ovonic memory, phase change memory, memristers, STT-MRAM, magnetic or optical cards, and any other type of storage media suitable for storing information.

In some examples, communications interface 1160 may include logic and/or features to support a communication interface. For these examples, communications interface 1160 may include one or more communication interfaces that operate according to various communication protocols or standards to communicate over direct or network communication links. Direct communications may occur via use of communication protocols such as SMBus, PCIe, NVMe, QPI, SATA, SAS, NVMf, S3, Swift, Kinetic or USB communication protocols. Network communications may occur via use of communication protocols such as Ethernet, Infiniband, SATA or SAS communication protocols.

Memory/storage device 1100 may be arranged as an SSD or an HDD that may be configured as described above for memory or storage device 120 of system 100 as shown in FIG. 1. Accordingly, functions and/or specific configurations of memory/storage device 1100 described herein, may be included or omitted in various embodiments of memory/storage device 1100, as suitably desired.

The components and features of memory/storage device 1100 may be implemented using any combination of discrete circuitry, ASICs, logic gates and/or single chip architectures. Further, the features of memory/storage device 1100 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the example memory/storage device 1100 shown in the block diagram of FIG. 11 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The follow examples pertain to additional examples of technologies disclosed herein.

Example 1. An example apparatus may include circuitry at a controller for a memory or storage device. The apparatus may also include receive logic for execution by the circuitry to receive a key-value put command that includes data for a key and data for a value, the data for the key and the data for the value to be stored to one or more first NVM devices maintained at the memory or storage device. The apparatus may also include store logic for execution by the circuitry to cause the data for the key and the data for the value to be stored in the one or more first NVM devices as an entry record at a physical address range. The apparatus may also include pointer logic for execution by the circuitry to add a pointer to a hash table to map a hash value to the entry record at the physical address range, the hash value generated via use of the data for the key, the hash table stored in one or more second NVM devices maintained at the memory or storage device.

Example 2. The apparatus of example 1, the pointer logic may add the pointer to the hash table comprises the pointer logic to add the pointer to a linked list used to select the pointer based on the hash value.

Example 3. The apparatus of example 1, the receive logic may receive a key-value get command that includes the data for the key stored with the data for the value. The pointer logic may use the data for the key to generate the hash value and select the pointer included in the hash table based on the hash value. The apparatus may also include read logic for execution by the circuitry to read the entry record stored in the one or more first NVM devices based on the pointer to obtain the data for the value. The apparatus may also include send logic for execution by the circuitry to send the data for the value to a source of the key-value get command.

Example 4. The apparatus of clam 1, the receive logic may receive a key-value delete command that includes the data for the key stored with the data for the value. The pointer logic may use the data for the key to generate the hash value. The pointer logic may delete the pointer included in the hash table stored in the one or more second NVMs based on the hash value and the key-value delete command.

Example 5. The apparatus of example 1 may also include journal logic for execution by the circuitry to cause the hash value to be maintained in a journal stored in the one or more first NVM devices.

Example 6. The apparatus of example 5, the journal may be stored at the one or more first NVM devices. The journal may be capable of maintaining a plurality of hash values used to obtain respective pointers to respective entry records at respective physical address ranges of the one or more first NVM devices. The respective entry records may store respective data for a plurality of keys and values in the one or more first NVM devices.

Example 7. The apparatus of example 5, the store may to cause the data for the key and the data for the value to be stored in the one or more first NVM devices at the physical address range based on a determination that the one or more first NVM devices have enough available storage capacity to store the data for the key, the data for the value and the journal.

Example 8. The apparatus of example 5, the receive logic may receive a second key-value put command that includes data for a second key and data for a second value. The data for the second key and the data for the second value to be stored to the one or more first NVM devices. The store logic may cause the data for the second key and the data for the second value to be stored in the one or more first NVM devices as a second entry record at a second physical address range. The pointer logic may add a second pointer to the hash table to map a second hash value to the second entry record at the second physical address range, the second hash value generated via use of the data for the second key. The journal logic may cause the second hash value to be maintained in the journal stored in the one or more first NVM devices.

Example 9. The apparatus of example 1, the entry record and the journal stored in the one or more first NVM devices may be stored in a first band included in the one or more first NVM devices.

Example 10. The apparatus of example 9, the receive logic may receive an indication to implement a defragmentation operation on the first band. The read logic may read data from the journal to determine which hashes maintained in the journal correspond to pointers included in the hash table stored in the one or more second NVM devices. The journal logic may determine that hashes having corresponding pointers include valid data in respective entry records for the corresponding pointers. The read logic may read the respective entry records. The relocate logic for execution by the circuitry may relocate the valid data in the respective entry records to a second band included in the one or more first NVM devices. The apparatus may also include erase logic for execution by the circuitry to erase the data stored in the first band.

Example 11. The apparatus of example 1, the one or more first NVM devices including NAND flash memory and the one or more second NVM devices including 3-dimensional cross-point memory that uses chalcogenide phase change material.

Example 12. The apparatus of example 1, the one or more first NVM devices or the one or more second NVM devices may include 3-dimensional cross-point memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

Example 13. The apparatus of example 1 may also include one or more of: a network interface communicatively coupled to the apparatus; a battery coupled to the apparatus; or a display communicatively coupled to the apparatus.

Example 14. An example method may include receiving, at a controller for a memory or storage device, a key-value put command that includes data for a key and data for a value, the data for the key and the data for the value to be stored to one or more first NVM devices maintained at the memory or storage device. The method may also include causing the data for the key and the data for the value to be stored in the one or more first NVM devices as an entry record at a physical address range. The method may also include adding a pointer to a hash table to map a hash value to the entry record at the physical address range. The hash value may be generated using the data for the key. The hash table may be stored in one or more second NVM devices maintained at the memory or storage device.

Example 15. The method of example 14, adding the pointer to the hash table may include adding the pointer to a linked list used to select the pointer based on the hash value.

Example 16. The method of example 14 may also include receiving a key-value get command that includes the data for the key stored with the data for the value. The method may also include using the data for the key to generate the hash value. The method may also include selecting the pointer included in the hash table based on the hash value. The method may also include reading the entry record stored in the one or more first NVM devices based on the pointer to obtain the data for the value. The method may also include sending the data for the value to a source of the key-value get command.

Example 17. The method of clam 14 may also include receiving a key-value delete command that includes the data for the key stored with the data for the value. The method may also include using the data for the key to generate the hash value. The method may also include deleting the pointer included in the hash table stored in the one or more second NVMs based on the hash value and the key-value delete command.

Example 18. The method of example 14 may also include causing the hash value to be maintained in a journal stored in the one or more first NVM devices.

Example 19. The method of example 15, the journal stored at the one or more first NVM devices may be capable of maintaining a plurality of hash values used to obtain respective pointers to respective entry records at respective physical address ranges of the one or more first NVM devices. The respective entry records may store respective data for a plurality of keys and values in the one or more first NVM devices.

Example 20. The method of example 18, causing the data for the key and the data for the value to be stored in the one or more first NVM devices at the physical address range based on a determination that the one or more first NVM devices have enough available storage capacity to store the data for the key, the data for the value and the journal.

Example 21. The method of example 18 may also include receiving a second key-value put command that includes data for a second key and data for a second value. The data for the second key and the data for the second value may be stored to the one or more first NVM devices. The method may also include causing the data for the second key and the data for the second value to be stored in the one or more first NVM devices as a second entry record at a second physical address range. The method may also include adding a second pointer to the hash table to map a second hash value to the second entry record at the second physical address range, the second hash value generated using the data for the second key. The method may also include causing the second hash value to be maintained in the journal stored in the one or more first NVM devices.

Example 22. The method of example 18, the entry record and the journal stored in the one or more first NVM devices may be stored in a first band included in the one or more first NVM devices.

Example 23. The method of example 22 may also include receiving an indication to implement a defragmentation operation on the first band. The method may also include reading data from the journal to determine which hashes maintained in the journal correspond to pointers included in the hash table stored in the one or more second NVM devices. The method may also include determining that hashes having corresponding pointers include valid data in respective entry records for the corresponding pointers. The method may also include reading the respective entry records. The method may also include relocating the valid data in the respective entry records to a second band included in the one or more first NVM devices. The method may also include erasing the data stored in the first band.

Example 24. The method of example 14, the one or more first NVM devices may include NAND flash memory and the one or more second NVM devices may include 3-dimensional cross-point memory that uses chalcogenide phase change material.

Example 25. The method of example 14, the one or more first NVM devices or the one or more second NVM devices may include 3-dimensional cross-point memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

Example 26. At least one machine readable medium may include a plurality of instructions that in response to being executed by a system may cause the system to carry out a method according to any one of examples 14 to 25.

Example 27. An apparatus may include means for performing the methods of any one of examples 14 to 25.

Example 28. An example at least one machine readable medium may include a plurality of instructions that in response to being executed by a system may cause the system to receive a key-value put command that includes data for a key and data for a value. The data for the key and the data for the value may be stored to one or more first NVM devices maintained at a memory or storage device. The instructions may also cause the system to cause the data for the key and the data for the value to be stored in the one or more first NVM devices as an entry record at a physical address range. The instructions may also cause the system to add a pointer to a hash table to map a hash value to the entry record at the physical address range. The hash value may be generated using the data for the key. The hash table may be stored in one or more second NVM devices maintained at the memory or storage device.

Example 29. The at least one machine readable medium of example 28, the instructions to cause the system to add the pointer to the hash table may include the system to add the pointer to a linked list used to select the pointer based on the hash value.

Example 30. The at least one machine readable medium of example 28, the instructions may further cause the system to receive a key-value get command that includes the data for the key stored with the data for the value. The instructions may also cause the system to use the data for the key to generate the hash value. The instructions may also cause the system to select the pointer included in the hash table based on the hash value. The instructions may also cause the system to read the entry record stored in the one or more first NVM devices based on the pointer to obtain the data for the value. The instructions may also cause the system to send the data for the value to a source of the key-value get command.

Example 31. The at least one machine readable medium of clam 28, the instructions may also cause the system to receive a key-value delete command that includes the data for the key stored with the data for the value. The instructions may also cause the system to use the data for the key to generate the hash value. The instructions may also cause the system to delete the pointer included in the hash table stored in the one or more second NVMs based on the hash value and the key-value delete command.

Example 32. The at least one machine readable medium of claim 28, the instructions may also cause the system to cause the hash value to be maintained in a journal stored in the one or more first NVM devices.

Example 33. The at least one machine readable medium of example 32, the journal stored at the one or more first NVM devices may be capable of maintaining a plurality of hash values used to obtain respective pointers to respective entry records at respective physical address ranges of the one or more first NVM devices. The respective entry records may store respective data for a plurality of keys and values in the one or more first NVM devices.

Example 34. The at least one machine readable medium of example 32, the instructions may cause the system to cause the data for the key and the data for the value to be stored in the one or more first NVM devices at the physical address range based on a determination that the one or more first NVM devices have enough available storage capacity to store the data for the key, the data for the value and the journal.

Example 35. The at least one machine readable medium of example 32, the instructions may further cause the system to receive a second key-value put command that includes data for a second key and data for a second value. The data for the second key and the data for the second value may be stored to the one or more first NVM devices. The instructions may also cause the system to cause the data for the second key and the data for the second value to be stored in the one or more first NVM devices as a second entry record at a second physical address range. The instructions may also cause the system to add a second pointer to the hash table to map a second hash value to the second entry record at the second physical address range. The second hash value may be generated using the data for the second key. The instructions may also cause the system to cause the second hash value to be maintained in the journal stored in the one or more first NVM devices.

Example 36. The at least one machine readable medium of example 32, the entry record and the journal stored in the one or more first NVM devices may be stored in a first band included in the one or more first NVM devices.

Example 37. The at least one machine readable medium of example 32, the instructions may further cause the system to receive an indication to implement a defragmentation operation on the first band. The instructions may also cause the system to read data from the journal to determine which hashes maintained in the journal correspond to pointers included in the hash table stored in the one or more second NVM devices. The instructions may also cause the system to determine that hashes having corresponding pointers include valid data in respective entry records for the corresponding pointers. The instructions may also cause the system to read the respective entry records. The instructions may also cause the system to relocate the valid data in the respective entry records to a second band included in the one or more first NVM devices. The instructions may also cause the system to erase the data stored in the first band.

Example 38. The at least one machine readable medium of example 28, the one or more first NVM devices may include NAND flash memory and the one or more second NVM devices may include 3-dimensional cross-point memory that uses chalcogenide phase change material.

Example 39. The at least one machine readable medium of example 28, the one or more first NVM devices or the one or more second NVM devices may include 3-dimensional cross-point memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
circuitry at a controller for a memory or storage device;
receive logic for execution by the circuitry to receive a key-value put command that includes data for a key and data for a value, the data for the key and the data for the value to be stored to one or more first NVM devices maintained at the memory or storage device;
store logic for execution by the circuitry to cause the data for the key and the data for the value to be stored in the one or more first NVM devices as an entry record at a physical address range; and
pointer logic for execution by the circuitry to add a pointer to a hash table to map a hash value to the entry record at the physical address range, the hash value generated via use of the data for the key, the hash table stored in one or more second NVM devices maintained at the memory or storage device.

2. The apparatus of claim 1, the pointer logic to add the pointer to the hash table comprises the pointer logic to add the pointer to a linked list used to select the pointer based on the hash value.

3. The apparatus of claim 1, comprising:
the receive logic to receiving a key-value get command that includes the data for the key stored with the data for the value;
the pointer logic to use the data for the key to generate the hash value and select the pointer included in the hash table based on the hash value;
read logic for execution by the circuitry to read the entry record stored in the one or more first NVM devices based on the pointer to obtain the data for the value; and
send logic for execution by the circuitry to send the data for the value to a source of the key-value get command.

4. The apparatus of clam 1, comprising:
the receive logic to receive a key-value delete command that includes the data for the key stored with the data for the value; and
the pointer logic to use the data for the key to generate the hash value; and
the pointer logic to delete the pointer included in the hash table stored in the one or more second NVMs based on the hash value and the key-value delete command.

5. The apparatus of claim 1, comprising:
journal logic for execution by the circuitry to cause the hash value to be maintained in a journal stored in the one or more first NVM devices.

6. The apparatus of claim 5, comprising the journal stored at the one or more first NVM devices, the journal capable of maintaining a plurality of hash values used to obtain respective pointers to respective entry records at respective physical address ranges of the one or more first NVM devices, the respective entry records to store respective data for a plurality of keys and values in the one or more first NVM devices.

7. The apparatus of claim 5, comprising the store logic to cause the data for the key and the data for the value to be stored in the one or more first NVM devices at the physical address range based on a determination that the one or more first NVM devices have enough available storage capacity to store the data for the key, the data for the value and the journal.

8. The apparatus of claim 5, comprising the entry record and the journal stored in the one or more first NVM devices are stored in a first band included in the one or more first NVM devices.

9. The apparatus of claim 7, comprising:
the receive logic to receive an indication to implement a defragmentation operation on the first band;
the read logic to read data from the journal to determine which hashes maintained in the journal correspond to pointers included in the hash table stored in the one or more second NVM devices;
the journal logic to determine that hashes having corresponding pointers include valid data in respective entry records for the corresponding pointers;
the read logic to read the respective entry records;
relocate logic for execution by the circuitry to relocate the valid data in the respective entry records to a second band included in the one or more first NVM devices; and
erase logic for execution by the circuitry to erase the data stored in the first band.

10. The apparatus of claim 1, comprising the one or more first NVM devices including NAND flash memory and the one or more second NVM devices including 3-dimensional cross-point memory that uses chalcogenide phase change material.

11. The apparatus of claim 1, comprising the one or more first NVM devices or the one or more second NVM devices including 3-dimensional cross-point memory that uses chalcogenide phase change material, flash memory, ferroelectric memory, silicon-oxide-nitride-oxide-silicon (SONOS) memory, polymer memory, ferroelectric polymer memory, ferroelectric transistor random access memory (FeTRAM or FeRAM), ovonic memory, nanowire, electrically erasable programmable read-only memory (EEPROM), phase change memory, memristors or spin transfer torque—magnetoresistive random access memory (STT-MRAM).

12. The apparatus of claim 1, comprising one or more of:
a network interface communicatively coupled to the apparatus;
a battery coupled to the apparatus; or
a display communicatively coupled to the apparatus.

13. A method comprising:
receiving, at a controller for a memory or storage device, a key-value put command that includes data for a key and data for a value, the data for the key and the data for the value to be stored to one or more first non-volatile memory (NVM) devices maintained at the memory or storage device;
causing the data for the key and the data for the value to be stored in the one or more first NVM devices as an entry record at a physical address range; and
adding a pointer to a hash table to map a hash value to the entry record at the physical address range, the hash value generated using the data for the key, the hash table stored in one or more second NVM devices maintained at the memory or storage device.

14. The method of claim 13, adding the pointer to the hash table comprises adding the pointer to a linked list used to select the pointer based on the hash value.

15. The method of claim 13, comprising:
receiving a key-value get command that includes the data for the key stored with the data for the value;
using the data for the key to generate the hash value;
selecting the pointer included in the hash table based on the hash value;
reading the entry record stored in the one or more first NVM devices based on the pointer to obtain the data for the value; and
sending the data for the value to a source of the key-value get command.

16. The method of clam 13, comprising:
receiving a key-value delete command that includes the data for the key stored with the data for the value;
using the data for the key to generate the hash value; and
deleting the pointer included in the hash table stored in the one or more second NVMs based on the hash value and the key-value delete command.

17. The method of claim 13, comprising:
causing the hash value to be maintained in a journal stored in the one or more first NVM devices.

18. The method of claim 17, comprising the journal stored at the one or more first NVM devices capable of maintaining a plurality of hash values used to obtain respective pointers to respective entry records at respective physical address ranges of the one or more first NVM devices, the respective entry records storing respective data for a plurality of keys and values in the one or more first NVM devices.

19. The method of claim 17, comprising:
the entry record and the journal stored in the one or more first NVM devices are stored in a first band included in the one or more first NVM devices;
receiving an indication to implement a defragmentation operation on the first band;
reading data from the journal to determine which hashes maintained in the journal correspond to pointers included in the hash table stored in the one or more second NVM devices;
determining that hashes having corresponding pointers include valid data in respective entry records for the corresponding pointers;
reading the respective entry records;
relocating the valid data in the respective entry records to a second band included in the one or more first NVM devices; and
erasing the data stored in the first band.

20. The method of claim 13, comprising the one or more first NVM devices including NAND flash memory and the one or more second NVM devices including 3-dimensional cross-point memory that uses chalcogenide phase change material.

21. At least one machine readable medium comprising a plurality of instructions that in response to being executed by a system cause the system to:
receive a key-value put command that includes data for a key and data for a value, the data for the key and the data for the value to be stored to one or more first non-volatile memory (NVM) devices maintained at a memory or storage device;
cause the data for the key and the data for the value to be stored in the one or more first NVM devices as an entry record at a physical address range; and
add a pointer to a hash table to map a hash value to the entry record at the physical address range, the hash value generated using the data for the key, the hash table stored in one or more second NVM devices maintained at the memory or storage device.

22. The at least one machine readable medium of claim 21, comprising the instructions to cause the system to add the pointer to the hash table comprises the system to add the pointer to a linked list used to select the pointer based on the hash value.

23. The at least one machine readable medium of claim 21, comprising the instructions to further cause the system to:
receive a key-value get command that includes the data for the key stored with the data for the value;
use the data for the key to generate the hash value;
select the pointer included in the hash table based on the hash value;
read the entry record stored in the one or more first NVM devices based on the pointer to obtain the data for the value; and
send the data for the value to a source of the key-value get command.

24. The at least one machine readable medium of clam 21, comprising the instructions to further cause the system to:
receive a key-value delete command that includes the data for the key stored with the data for the value;
use the data for the key to generate the hash value; and
delete the pointer included in the hash table stored in the one or more second NVMs based on the hash value and the key-value delete command.

25. The at least one machine readable medium of clam 21, comprising the instructions to further cause the system to:
cause the hash value to be maintained in a journal stored in the one or more first NVM devices.

26. The at least one machine readable medium of claim 25, comprising the journal stored at the one or more first NVM devices capable of maintaining a plurality of hash values used to obtain respective pointers to respective entry records at respective physical address ranges of the one or more first NVM devices, the respective entry records storing respective data for a plurality of keys and values in the one or more first NVM devices.

27. The at least one machine readable medium of claim 25, comprising the instructions to cause the system to cause the data for the key and the data for the value to be stored in the one or more first NVM devices at the physical address range based on a determination that the one or more first NVM devices have enough available storage capacity to store the data for the key, the data for the value and the journal.

28. The at least one machine readable medium of claim 24, comprising the entry record and the journal stored in the one or more first NVM devices are stored in a first band included in the one or more first NVM devices.

29. The at least one machine readable medium of claim 20, comprising the instructions to further cause the system to:
receive an indication to implement a defragmentation operation on the first band;
read data from the journal to determine which hashes maintained in the journal correspond to pointers included in the hash table stored in the one or more second NVM devices;
determine that hashes having corresponding pointers include valid data in respective entry records for the corresponding pointers;
read the respective entry records;
relocate the valid data in the respective entry records to a second band included in the one or more first NVM devices; and
erase the data stored in the first band.

30. The at least one machine readable medium of claim 20, comprising the one or more first NVM devices including NAND flash memory and the one or more second NVM devices including 3-dimensional cross-point memory that uses chalcogenide phase change material.
